(19) United States
(12) Patent Application Publication
(10) Pub. No.: US 2013/0161999 A1
(43) Pub. Date: Jun. 27, 2013

(54) Chair Connector System and Method of Assembly

(71) Applicants: Moses Richard Schultz, Brattleboro, VT (US); Michael Isaac Weaker, North Potomac, MD (US); Matthew A. Sommerfield, Allentown, PA (US)

(72) Inventors: Moses Richard Schultz, Brattleboro, VT (US); Michael Isaac Weaker, North Potomac, MD (US); Matthew A. Sommerfield, Allentown, PA (US)

(21) Appl. No.: 13/334,987

(22) Filed: Dec. 22, 2011

(51) Int. Cl. A47C 7/00; B23P 11/00; A47C 7/02

(52) U.S. Cl. 297/452.2; 29/525.02

(57) ABSTRACT

There is provided in a preferred embodiment of the present invention a connector system and method of assembly comprising a chair having two opposite frame members and two opposite seat frames, wherein the seat frames are connected to the frame members by respective connector assemblies. Further, the frame members are connected to each other by a plurality of lateral rods, each lateral rod being fixed to both frame members by a lateral rod stud.

### FIELD OF THE INVENTION

This invention relates generally to the field of furniture connector systems. More specifically, this invention involves a connector system for a chair or similar furniture units, which minimizes the appearance of seams and connection parts. In a preferred embodiment, the connector system includes a connector assembly for securing the inside of a frame member to the inside of a seat frame.

### BACKGROUND OF THE INVENTION

Conventional wood furniture is assembled using nuts and bolts and other visible fastening devices. Metal and plastic furniture are generally assembled in a manner similar to wooden furniture.

There are several problems associated with conventional furniture assembly devices. For example, nuts and bolts are visible to the user and detract from the appearance of the furniture. Further, exterior fasteners of this type tend to attract debris and rust and are more difficult to clean, and may often “catch” on clothing or “scratch” a user.

Another furniture assembly technique, exterior welding, is limited because it leaves visible seams, lacks strength and is difficult to disassemble. Welding the exterior of one element to the exterior of an adjacent element requires melting the metal at the junction and/or adding melted metal to the area to fix the two elements together. The melted metal generally forms a visible seam, which detracts from the appearance of the furniture. Additionally, it is often costly, as it requires skilled labor.

Further, a welding junction can only be disassembled by melting the metal in the junction. This process requires specialized welding equipment and greatly limits the ability to disassemble the furniture.

### SUMMARY OF THE INVENTION

In view of the deficiencies and drawbacks in the prior furniture assembly and connection art, it is a primary object of the present invention to provide an improved chair connector system and method of assembly that minimizes the visibility of junctions.

Another object of the present invention is to provide an improved connector assembly for chairs and other furniture units that provides additional strength when working with lighter metals such as aluminum.

A further object of the present invention is to provide a simple and efficient method of manufacturing a chair connector system.

In summary, there is provided in a preferred embodiment of the present invention a connector system and method of assembly comprising a chair having two opposite frame members and two opposite seat frames, wherein the seat frames are connected to the frame members by respective connector assemblies. Further, the frame members are connected to each other by a plurality of lateral rods, each lateral rod being fixed to both frame members by a pair of lateral rod studs.

### BRIEF DESCRIPTION OF THE DRAWINGS

FIG. 1 is a perspective view of a chair incorporating a first embodiment of a chair connector system, the same utilizing the method of assembly of the present invention;

FIG. 2 is a rear view thereof;

FIG. 3 is an exploded perspective view of the connector assembly and the middle lateral rod connected to the right frame member of the first embodiment of the connector system, the same utilizing the method of assembly of the present invention;

FIG. 4 is a perspective view of a lounge, incorporating a second embodiment of the connector system, the same utilizing the method of assembly of the present invention;

FIG. 4A is a rear view thereof;

FIG. 5 is a perspective view of said chair shown in FIGS. 1 through 3, and specifically of the right seat frame connected to the connector assembly, and the connector assembly, middle lateral rod and bottom lateral rod, all connected to the right frame member of the connector system, the same utilizing the method of assembly of the first embodiment of the present invention;

FIG. 6 is a cross section view of the connector assembly and the seat frame of the connector system, the same utilizing the method of assembly of the present invention, taken along line 6-6 of FIG. 5;

FIG. 7 is a cross section view of the seat frame, connector assembly and frame member of the connector system, the same utilizing the method of assembly of the present invention, taken along the line 7-7 of FIG. 6;

FIG. 8 is a cross section view of a lateral rod and a frame member of the connector system, the same utilizing the method of assembly of the present invention, taken along line 8-8 of FIG. 5;

FIG. 9 is a perspective view of the seat frame, upper lateral rod, connector assembly and frame member of the connector system, the same utilizing the method of assembly of the present invention, as to the chair shown in FIG. 1;

FIG. 10 is a cross section view of the seat frame cap and seat frame of the connector system, utilizing the method of assembly of the present invention, taken along the line 10-10 of FIG. 9;

FIG. 11 is a cross section view of the seat frame and fabric seat of the connector system, the same utilizing the method of assembly of the present invention, taken along the line 11-11 of FIG. 9;

FIG. 11A is a perspective view of the cord and cord sleeve of the connector system, the same utilizing the method of assembly of the present invention;

FIG. 11B is a cross section view of the cord, cord sleeve and fabric seat of the connector system, the same utilizing the method of assembly of the present invention;

FIG. 12 is an exploded perspective view of the bullet pin assembly of a second embodiment of the connector system, the same utilizing the method of assembly of the present invention, of the lounge of FIG. 4;

FIG. 13 is an exploded perspective view of the tilt bar assembly of the second embodiment of the connector system, the same utilizing the method of assembly of the present invention, of the lounge of FIG. 4;

FIG. 14 is perspective view of the seat frame, lateral rod, connector assembly, tilt bar and frame connector of the second embodiment of the connector system, the same utilizing the method of assembly of the present invention;

FIG. 15 is a cross section view of the bullet pin assembly of the second embodiment of the connector system, the same utilizing the method of assembly of the present invention, taken along the line 15-15 of FIG. 14; and

FIG. 16 is a cross section view of the tilt bar assembly of the second embodiment of the connector system, the same utilizing the method of assembly of the present invention, taken along the line 16-16 of FIG. 14.

### DETAILED DESCRIPTION OF THE INVENTION

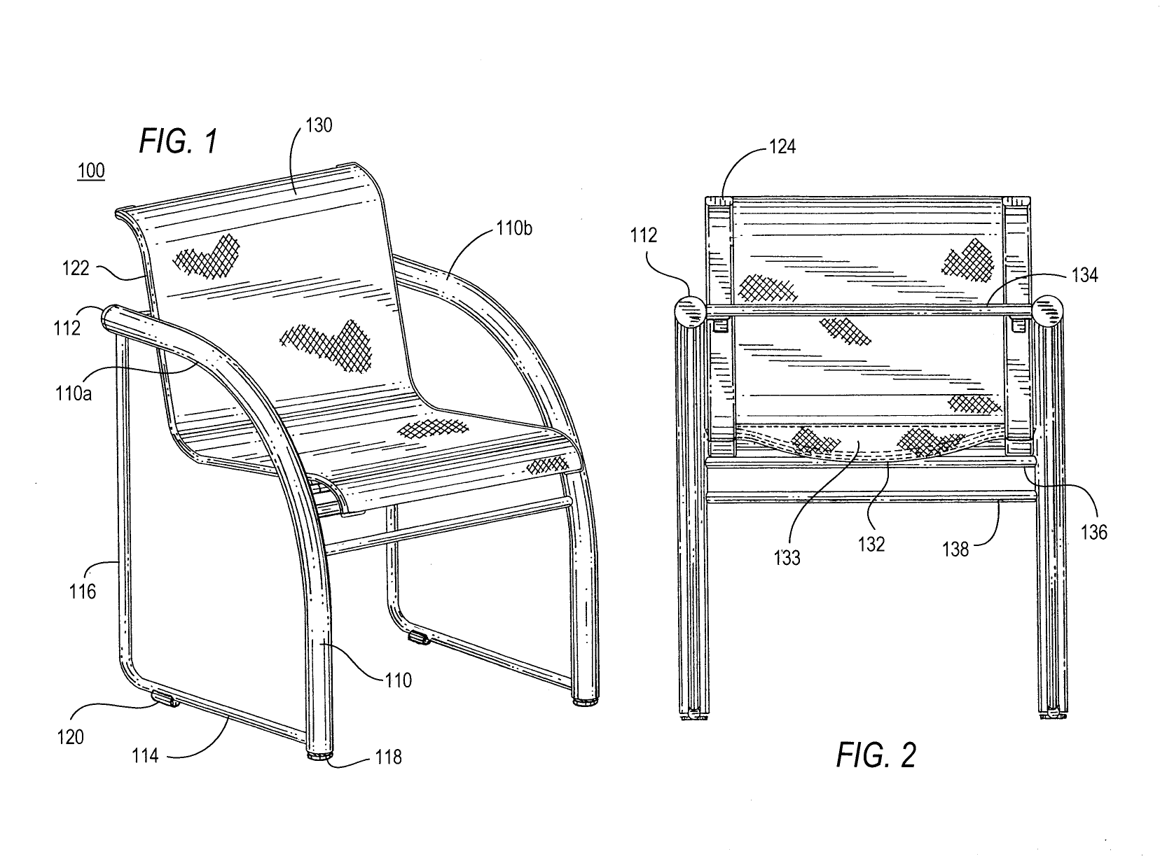

With reference to FIGS. 1 and 2, there is shown a first preferred embodiment of a chair 100 of the present invention. Chair 100 includes a frame member 110, a base frame rod 114, a vertical frame rod 116, and a seat frame 122. The frame member 110 and the seat frame 122 are preferably formed from aluminum extrusion tubes. The frame member 110 further includes a frame member cap 112 and the seat frame 122 further includes a seat frame cap 124. Each of the frame member 110, the base frame rod 114, the vertical frame rod 116, the seat frame 122 and additional elements described herein include matching left and right mirror elements. Where only one of the mirror elements is described, it should be understood that the opposite element mirrors the described element in form and function.

Base frame rod 114 is substantially parallel to the ground and connects at the front to frame member 110 and at the rear to vertical frame rod 116. At the rear of the chair 100, vertical frame rod 116 extends from base frame rod 114 to frame member 110. Both base frame rod 114 and vertical frame rod 116 are preferably welded to frame member 110. Further included on the bottom of base frame rod 114 are front feet 118 and rear feet 120.

The frame member 110 further includes right frame member 110a and left frame member 110b, both curved in the shape of a quarter circumference of a circle. Connecting right frame member 110a to left frame member 110b are top lateral rod 134, middle lateral rod 136 and bottom lateral rod 138. The connection of the lateral rods 134, 136, 138 to the frame member 110 is discussed in detail below.

Also connected to frame member 110 is seat frame 122. Seat frame 122 is forwardly opening and supports a fabric seat 130. The fabric seat 130 is preferably a mesh fabric that is fixed to seat frame 122 as described below. As illustrated in FIG. 2, the chair 100 includes a tension bar 132, contained within tension bar cover 133, which is an integrated element of the fabric seat 130. The tension bar 132 is preferably positioned on the underside of chair 100 and has a curved shape. The tension bar 132, in conjunction with the tension bar cover 133, maintains the tautness of fabric seat 130.

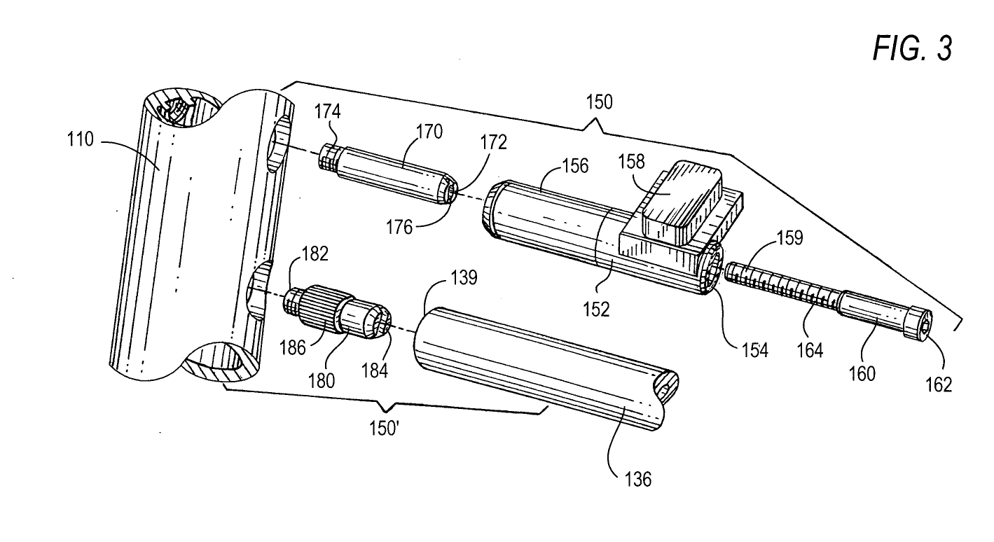

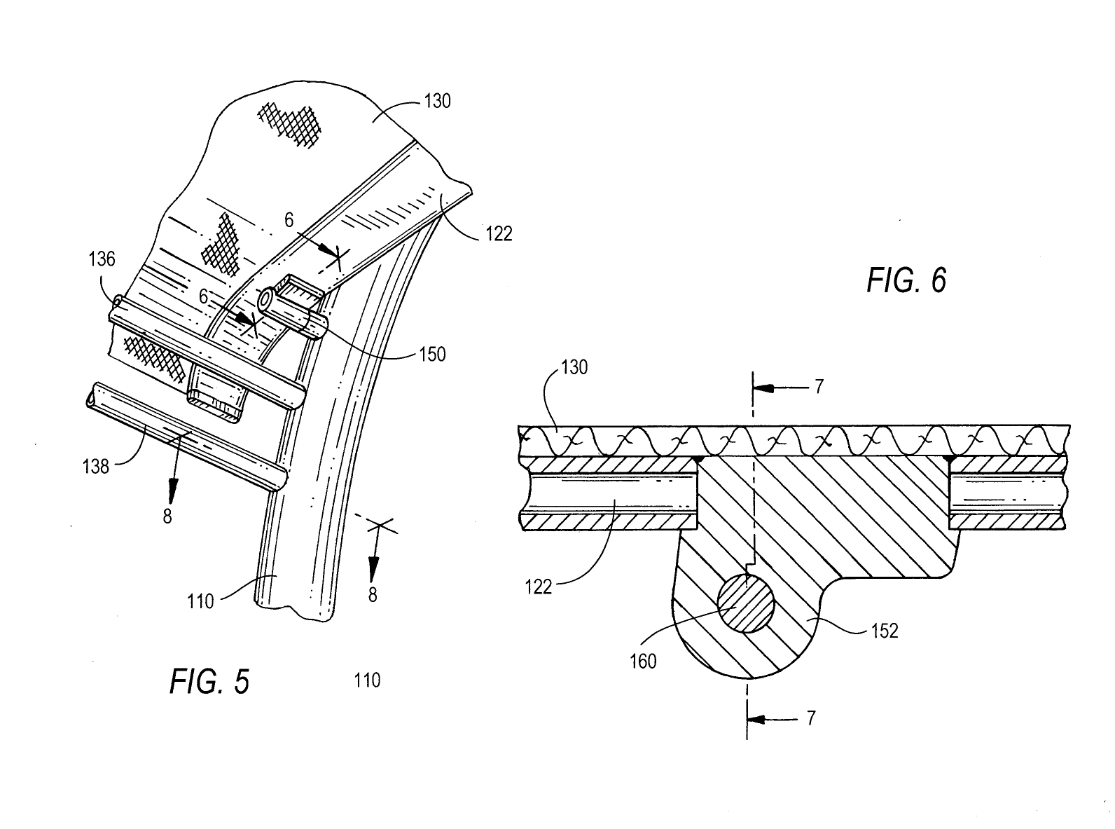

As illustrated in FIGS. 3, 5, 6 and 7, connected to frame member 110 is a first connector assembly 150. As shown in FIGS. 5 and 6, connector assembly 150 connects the frame member 110 to the seat frame 122. The connector assembly 150 includes a frame connector 152, a bolt 160 and a connector stud 170. The connector stud 170 further includes a threaded head 174 and a distal end 176, having a threaded opening 172. The threaded head 174 of the stud 170 screws into a threaded opening 140 of the frame member 110. In order to facilitate this engagement, the distal end 176 of connector stud 170 includes a flat head screwdriver interface.

The frame connector 152 has a cylindrical bore or opening 154 which is sized and shaped to receive and enclose connector stud 170. The cylindrical opening 154 extends fully through frame connector 152 and receives the bolt 160 in the opposite end from which it receives the connector stud 170. The bolt 160 includes a bolt head 162 and a bolt threaded body 164. The bolt threaded body 164 engages the threaded opening 172 of the connector stud 170, thereby securing the assembly 150 to the frame member 110.

As best shown in FIGS. 5 through 7, the frame connector 152 further includes a sleeve 156 and a frame fastener 158. The sleeve 156 is cylindrical in shape and is rotatable relative to the frame connector 152. The sleeve 156 is positioned adjacent to frame connector 110 and facilitates installation by preventing abrasion between the frame member 110 and the frame connector 152.

The fastener 158 is inserted into and fixed in an opening 125 in the seat frame 122. Fastener 158 is preferably welded to seat frame 122, though it may be fixed by other conventional means. As shown in FIG. 6, fastener 158 extends through seat frame 122 to abut mesh seat 130.

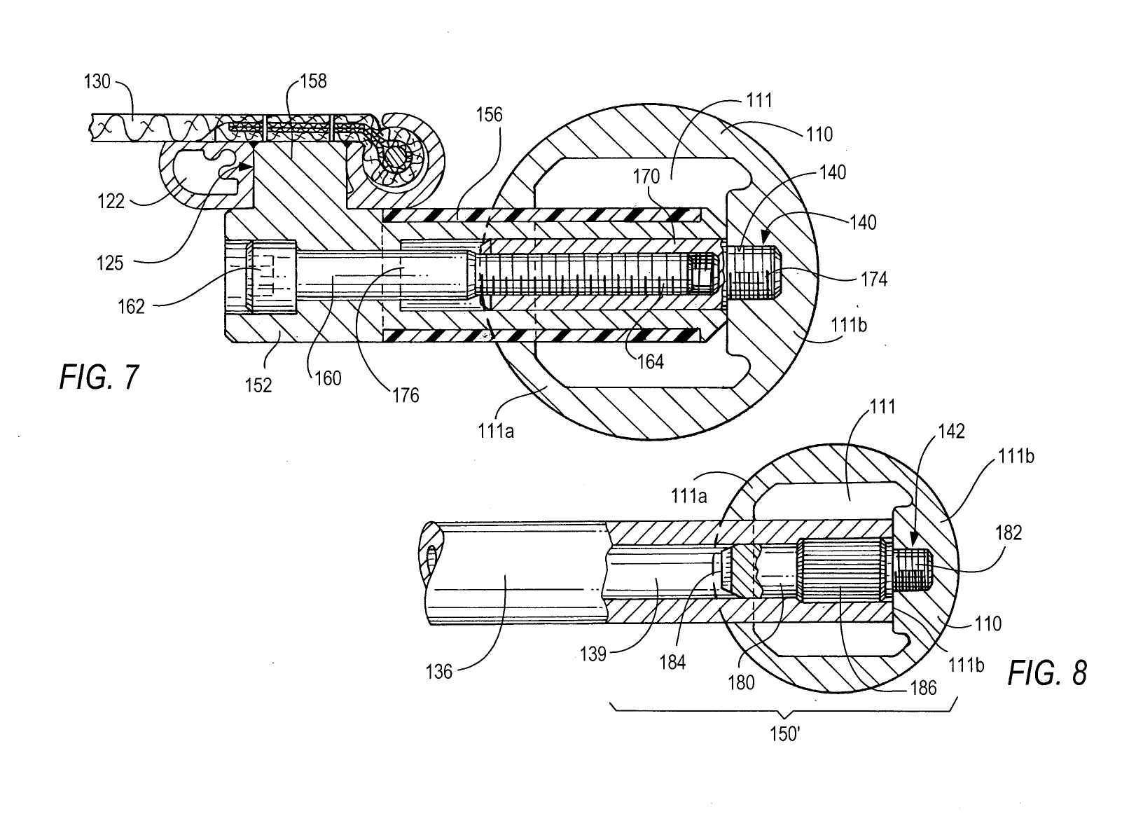

The fully assembled first connector assembly 150 is most clearly shown in cross-section FIG. 7. As seen there, the frame member 110 is an extruded member, having a hollow interior 111, defined in part by a curved proximal wall portion 111a and a distal wall portion 111b. The connector stud 170 is positioned partially inside of the interior of the frame member 110 and the head 174 of connector stud 170 is threaded into a threaded opening 140 of the wall portion 111b of the frame member 110. The frame connector 152 passes through an opening 141 in the proximal wall portion 111a and is positioned partially inside the interior 111 of the frame member 110. The frame connector 152 is further positioned cylindrically over the connector stud 170, such that the connector stud 170 is located inside the bore 154 of frame connector 152. The frame connector 152 is held in place by the bolt 160, the latter being positioned inside the bore 154 of frame connector 152 and inside connector stud 170. Specifically, the bolt threaded body 164 is threadedly engaged to the threaded opening 172. The bolt 160 holds the first connector assembly 150 in a substantially fixed lateral position since the head 162 of the bolt 160 applies a force against the frame connector 152 in one direction, toward the interior wall portion 111b, and the bolt threaded body 164 applies a force against the fixed connector stud 170 in the opposite direction. The sleeve 156 is cylindrically wrapped around frame connector 152 and is free is rotate relative to frame connector 152.

As shown in FIG. 3 and in the cross-section in FIG. 8, the present invention preferably includes a second connector assembly 150′. The second connector assembly 150′ provides a connection between the middle lateral rod 136 and the frame member 110 utilizing a lateral rod stud 180. The lateral rod stud 180 includes a threaded body 182 at one end, a stud head 184 at the other end and a ribbed mid-section 186. The lateral rod stud 180 is connected to a threaded opening 142 in the distal wall portion 111b, which in part defines the interior 111 of the frame member 110, by the stud threaded body 182. The engagement of the lateral rod stud head 184 to the threaded opening 142 is facilitated by the flat head screwdriver interface of lateral rod stud head 184. The lateral rod 136 is cylindrical with a central bore or opening 139. The ribbed mid-section 186 extends radially outward from the lateral rod stud 180 and is sized and shaped to create a compression fit with the opening 139 of the middle lateral rod 136. When connecting the middle lateral rod 136 to the connector stud 180, a significant force may be necessary to engage the interference fit connection.

The fully assembled second connector assembly 150′ is most clearly shown in FIG. 8. The lateral rod stud 180 is positioned partially inside the interior 111 of the frame member 110, such that threaded body 182 is threaded into threaded opening 142 in wall portion 111b, thereby securing stud 180 to frame member 110. The bottom lateral rod 136 is positioned over the ribbed mid-section 186 of stud 180 forming a compression fit which secured the lateral rod 138 to the stud 180 and the frame member 110.

It should be understood that while the connection of the frame member 110 to the middle lateral rod 136 is shown, substantially identical connections are employed for the opposite end of the middle lateral rod 136 and both ends of the top lateral rod 134 and the bottom lateral rod 138.

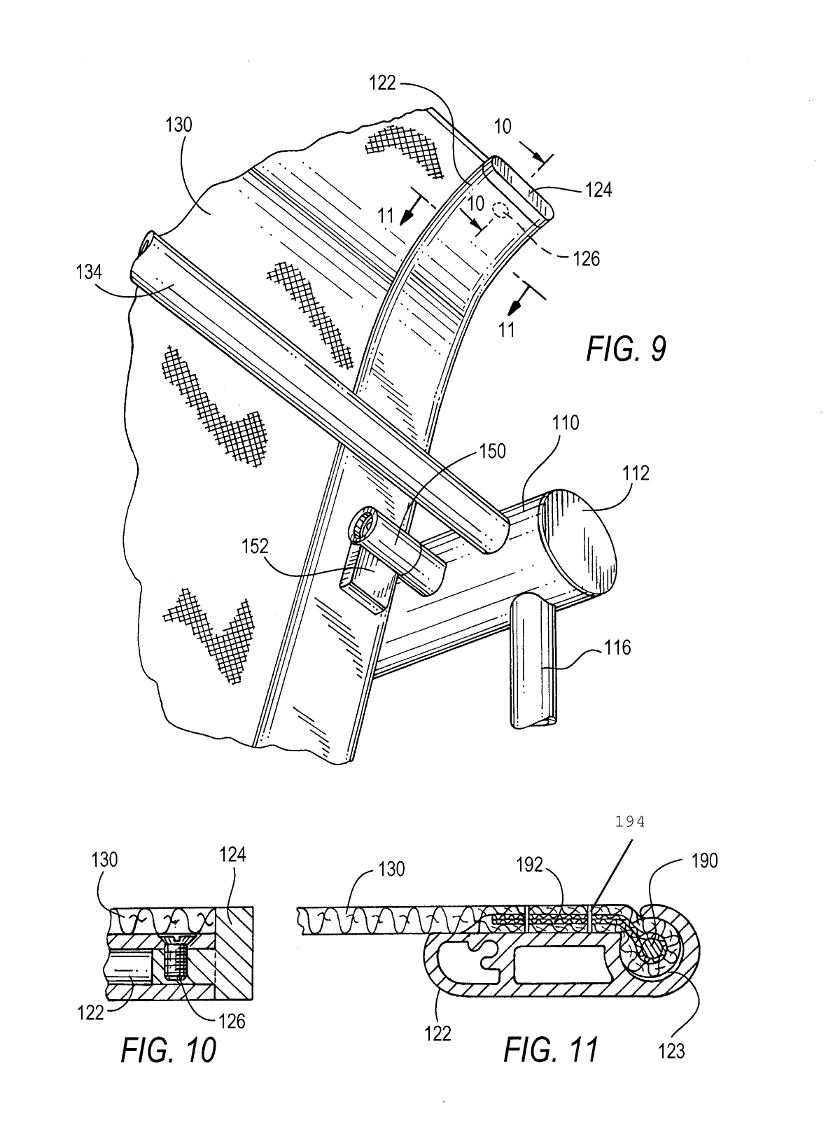

With reference to FIGS. 9 through 11b, the seat frame 122 and the fabric seat 130 are illustrated in detail. The seat frame 122 is connected to the frame member 110 by the first connector assembly 150, as described above. The seat frame 122 further includes a seat frame cap 124, which is secured to the seat frame 122 by a cap bolt 126. The cap bolt 126 is inserted on the front side of the seat frame 122, whereby it is covered by the fabric seat 130, upon complete assembly.

As illustrated in FIGS. 11, 11a and 11b, the fabric seat 130 is secured to the seat frame 122 by a cord 190 which is enclosed by a cord sleeve 192. The cord sleeve 192 is preferably melted to itself and the cord 190. The fabric seat 130 wraps around the combination of the cord 190 and the cord sleeve 192. The fabric seat 130 and the cord sleeve 192 are sewn together by stitches 194.

Seat frame 122 includes a cord attachment slot 123, best illustrated in FIG. 11. The stitched combination of cord 192, cord sleeve 194 and fabric seat 130 is slid into the cord attachment slot 123 prior to the attachment of the seat frame cap 124, and is held in place by an interference fit.

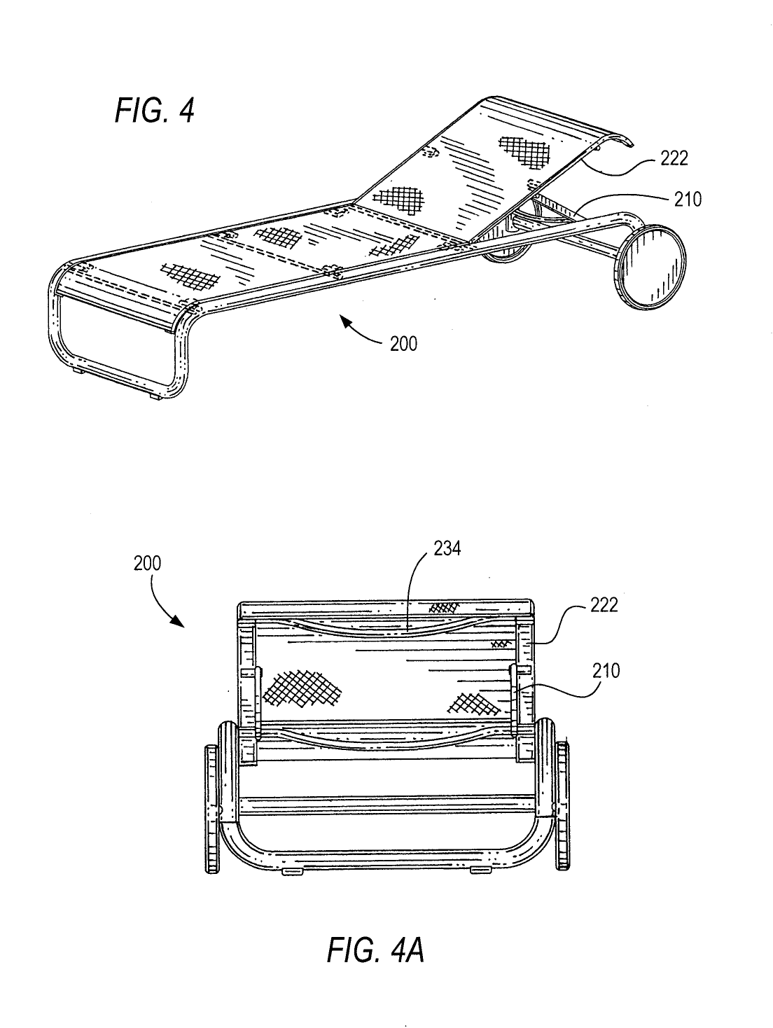

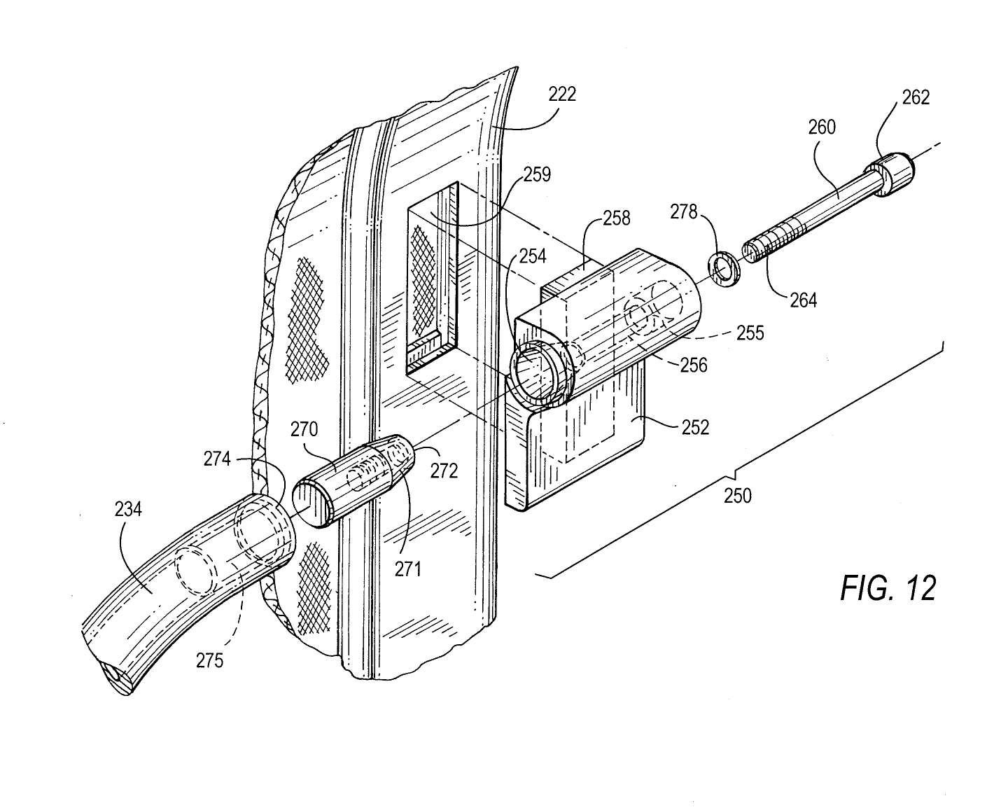

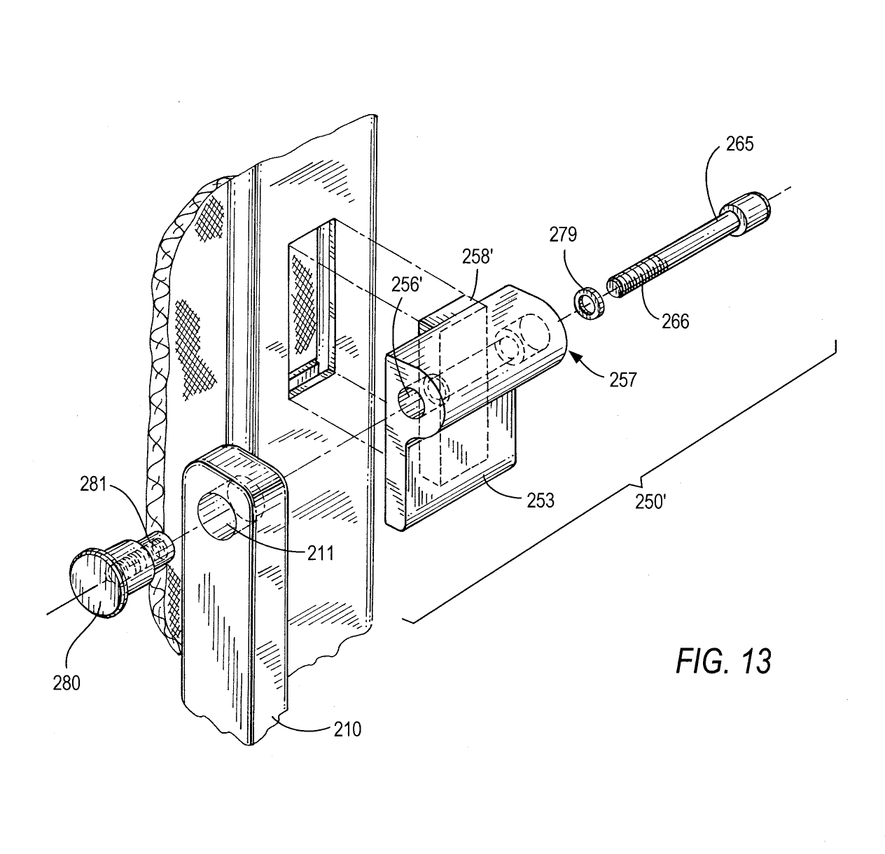

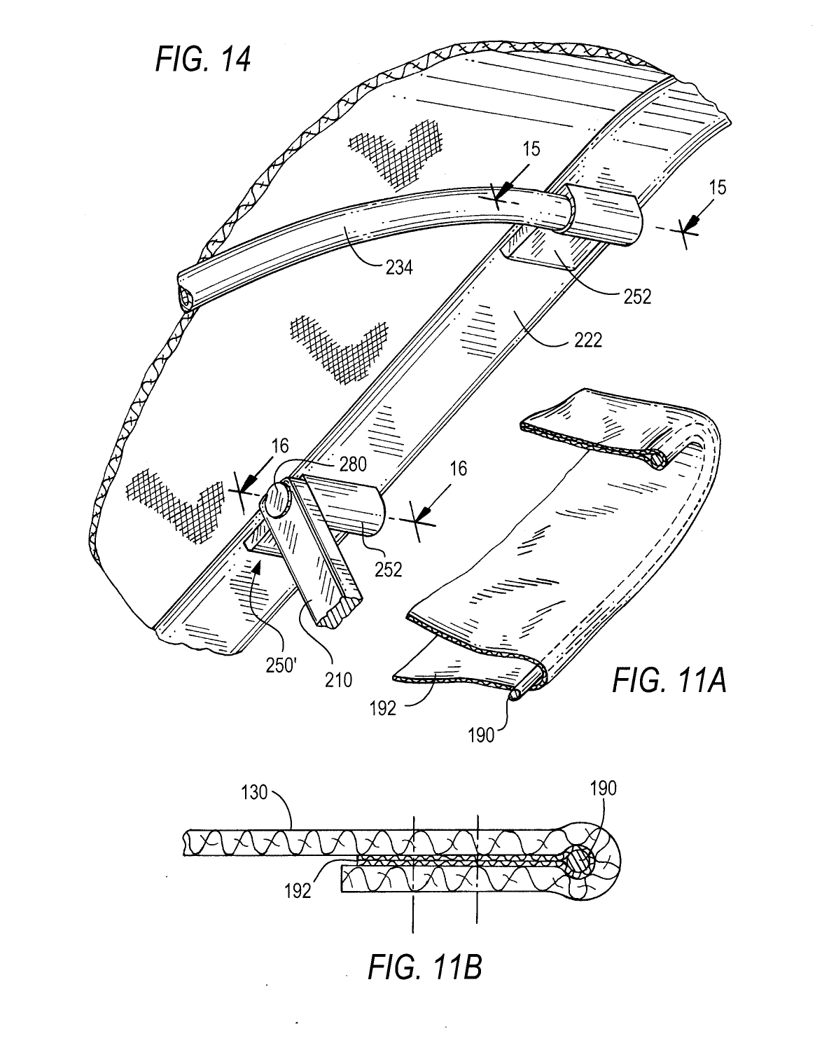

With reference to FIGS. 4, 4A and 12 through 16, there is shown a second preferred embodiment of the connector system, as applied to a chaise 200. The chaise 200 includes a lateral rod 234 and a seat frame 222. A third connector assembly 250 is utilized for connecting the lateral rod 234 to the seat frame 222, as illustrated in FIGS. 12, 14 and 15; a fourth connector assembly 250′ is utilized for rotatably connecting a tilt bar 210 to seat frame 222, as illustrated in FIGS. 13, 14 and 16. As best shown in FIG. 14, the third connector assembly 250 and fourth connector assembly 250′ are both positioned on the underside of seat frame 222.

The third connector assembly 250 includes a frame connector 252, a bullet pin 270, a washer 278 and a bolt 260 with a threaded bolt body 264 and a head 262. The frame connector 252 further includes a tapered opening 254 for receiving the bullet pin 270, a second opposite opening 255 for receiving the washer 278 and a bore 256 for receiving the bolt 260. Additionally, the frame connector 252 includes a rectangular fastener 258 for connecting to an opening 259 in the seat frame 222. The bullet pin further includes a tapered bullet head 271, a threaded opening 272 for engaging the body 264 to the bolt 260, a collar 274 and an opening 275 for permanently connecting to the lateral rod 234.

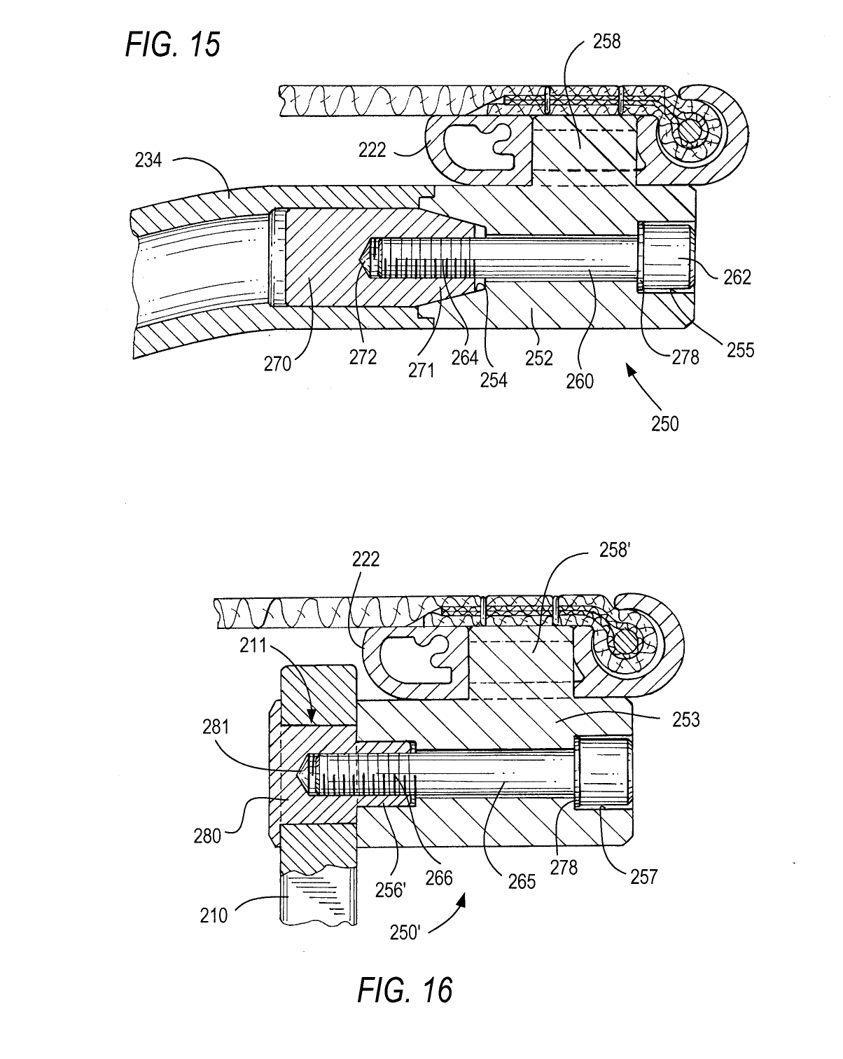

As best illustrated in the cross-section shown in FIG. 15, the washer 278 and the bolt 260 are inserted into the second opening 255 of the frame connector 252. The bullet pin 270 is inserted into the opposite tapered opening 254 such that the bolt threaded body 264 engages the threaded opening 272 of the bullet pin 270. The turning of the bolt head 262 secures the bullet pin 270 to the frame connector 252. Frame connector 252 is further fixed to seat frame 222, preferably by welding. The bullet pin 270 is further fixedly connected to lateral rod 234 by a collar 274.

As best shown in FIG. 13, 14 and in the cross-section of FIG. 16, the tilt bar 210 is connected to the seat frame 222 by the fourth connector assembly 250′. The tilt bar 210 is a commonly known structure rotatably connected to the seat frame at one end and selectively attached to the frame of chair 200 at its distal end. The fourth connector assembly 250′ includes a frame connector 253. The frame connector 253 includes a fastener 258′, a nut opening 256′, a washer 279 and a bolt opening 257. A headed nut 280 is inserted through opening 211 and into the nut opening 256′ of frame connector 253, such that the tilt bar 210 may still rotate relative to the nut 280. The nut 280 further includes a threaded opening 281. A bolt 265 is inserted into the bolt opening 257 in the connector 253 and a threaded body 266 of bolt 265 engages the threaded opening 281 of nut 280, thereby securing the tilt bar 210 to the seat frame 222.

In addition to the system described above, the present invention includes a method of assembly. The preferred method of assembling the first connector system 150 of the chair 100 or similar article of furniture of the present invention includes fixing the fastener 158 of the connector assembly 150 to the seat frame 122, preferably by welding. Second, the fabric seat 130 is attached to the seat frame 122. Third, the connector stud 170 is attached to the frame member 110. Fourth, the frame connector 152, having an opening 154, is positioned over the connector stud 170 such that the distal end 176 of the connector stud 170 is inserted into the opposite end 155 of opening 154. And fifth, the bolt 160 is positioned through opening 154 to engage the threaded opening of the distal end 176 of connector stud 170.

Further provided is a preferred method of assembling the second connector assembly 150′, which connects the lateral rods 134, 136, 138 to the frame member 110. This preferred method includes the following steps, which are preferably performed in the following order but may be performed in varying orders. First, the lateral rod stud 180 is attached the frame connector 110. Second, one of lateral rods 134, 136, 138 is fixed to a lateral rod stud such as stud 180 by a compression fit between the ribbed body 186 of the lateral rod stud 180 and the interior of the lateral rod 134, 136, 138. The method of connecting the lateral rod studs 134, 136, 138 to the frame member 110, is preferably employed in conjunction with the above described method of connecting the seat frame 122 to the frame member 110 using the connector assembly 150.

When assembling the connector system of both the first and second embodiments, the following steps are preferably utilized to assemble the seat frame 122 and fabric seat 130. First, the cord 190 is enclosed in the cord sleeve 192. The cord 190 and cord sleeve 192 are then melted together. Next, the combination of the cord 190 and the cord sleeve 192 are stitched to the fabric seat 130 as illustrated in FIG. 11b. Further, as shown in FIG. 11, the cord 190 is inserted into the cord attachment slot 123. Preferably, cord attachment slot 123 includes a lateral opening, a top opening and a bottom opening. The lateral opening extends along the length of seat frame 122 and is wide enough to allow the combination of the fabric seat 130 and cord sleeve 192 to be positioned within it, but is narrow enough to hold the cord 190 in the cord attachment slot 123. Accordingly, cord 190 is inserted in the cord attachment slot 123 through either the top opening or the bottom opening. Once installed in the cord attachment slot 123, seat frame cap 124 is fixed to the seat frame 122 enclosing the cord 190 and securing the fabric seat 130 in place. Lastly, the expansion bar 132 is inserted into the expansion bar cover 133 and is fixed to frame member 110 at both ends.

The preferred method of assembling the chaise 200 of the present invention includes steps similar to those of assembling the chair 100. For assembling the chaise 200 in connection with the third connector assembly 250, the fastener 258 is preferably welded to opening 259 of the seat frame 222. Next, the bullet pin 270 is secured to the collar 274 of the lateral rod 234. The head 271 of the bullet pin 270 is then inserted into the tapered opening 254 of the frame connector 252. Next, the washer 278 and the bolt 260 are inserted into the second opening 255 of frame connector 252. The bolt threaded body 264 is then secured to the threaded opening 272 of the bullet pin 270, thereby securing the bullet pin 270 to the frame connector 252.

In connection with the fourth connector assembly 250′, the frame connector 253 is preferably welded to the seat frame 122, as shown in FIG. 16. Then the nut 280 is inserted through the opening 211 of the tilt bar 210 and into the nut opening 256 of frame connector 253. Next, the washer 279 and the bolt 265 are inserted into the bolt opening 257 of the frame connector 253. The threaded body of bolt 266 is fixed to the threaded opening 281 of the nut 280, thereby securing the nut 280 to the tilt bar 210 and the frame connector 253.

The accompanying drawings only illustrate two embodiments of a connector system and method of assembly and its respective constituent parts and steps, however, other types and styles are possible, and the drawings are not intended to be limited in that regard. Thus, although the description above and accompanying drawings contains much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

1. In an article of furniture having a pair of frame members and a seat frame holding a fabric, the seat frame situated between the frame members, a connector system for connecting the frame members to the seat frame, comprising:
a frame connector with a bore, and including a fastener;
an opening in the seat frame, the fastener being fixed to the opening in the seat frame;
an opening in at least one of the frame members;
a connector stud, having a head at one end and an opening in the opposite end, the head of the connector stud being secured in the opening of the frame member and the stud being located in the bore of the frame connector; and
a bolt, having a bolt body, the bolt body located in and connecting the connector to the opening of the connector stud.

2. In an article of furniture having a pair of frame members, a seat frame located between the frame members and holding a fabric, and a plurality of lateral rods located between the frame members, a connector system for connecting the frame members to the seat frame and connecting the lateral rods to the frame members, comprising:
a first connector assembly including:
a frame connector with a bore, and including a fastener;
an opening in the seat frame, the fastener being fixed to the opening in the seat frame;
an opening in at least one of the frame members;
a connector stud, having a head at one end and an opening in the opposite end, the head of the connector stud being secured in the opening of the frame member and the stud being located in the bore of the frame connector; and
a bolt, having a bolt body, the bolt body located in and connecting the connector to the opening of the connector stud;
a second connector assembly including:
a second stud for connecting a lateral rod to the frame members, the second stud including a threaded head and ribbed section, the threaded head being connected to a second opening in the frame member;
wherein the ribbed section is fixed to an opening in the lateral rod by a compression fit.

3. The connector system for connecting the frame members to the seat frame of claim 1, wherein the connector stud is enclosed within the frame member and the frame connector.

4. The connector system for connecting the frame members to the seat frame of claim 1, wherein the fastener is welded to the seat frame.

5. The connector system for connecting the frame members to the seat frame of claim 1, further comprising a fabric seat connected to the seat frame, wherein the fabric seat includes a cord which is secured in an attachment slot of the seat frame.

6. The connector system for connecting the frame members to the seat frame of claim 5, further comprising a tension bar exerting a tension force on the fabric seat.

7. The connector system for connecting the frame members to the seat frame of claim 6, wherein the tension bar is positioned on the underside of the chair and has a rounded shape.

8. The connector system for connecting the frame members to the seat frame of claim 1, wherein the frame member and the seat frame are extrusion tubes.

9. In an article of furniture having a pair of frame connectors, a lateral rod and a seat frame holding a fabric, a connector system for connecting the lateral rod to the seat frame, comprising:
a frame connector, having a first opening, an opposite second opening and a fastener, said fastener connecting said lateral rod to said seat frame;
a bullet pin, having a head, a threaded opening and a collar, the head sized to fit into the first opening, and the collar adapted to connect to said lateral rod;
a bolt having a threaded body and being positioned through the second opening of the frame connector and in the first opening, wherein the threaded body of the bolt engages the threaded opening of the bullet pin.

10. The connector system for connecting the lateral rod to the seat frame of claim 9, wherein the frame connector is fixed to a seat frame and the bullet pin is fixed to a lateral rod.

11. The connector system for connecting the lateral rod to the seat frame of claim 9, wherein the first opening and the head are tapered.

12. In an article of furniture having a pair of frame members, a seat frame holding a fabric, the seat frame situated between the frame members, and a pair of tilt bars for adapting the position of the seat frame, a connector system for connecting a tilt bar to the seat frame, comprising:
a frame connector, having a fastener, a first opening, and an opposite second opening, wherein a nut having a threaded opening is positioned through the first opening and into the second opening; and
a bolt inserted into the opposite second opening and engaging the threaded opening of the nut, thereby securing the nut and frame member to the frame connector;
wherein the fastener is connected to a third opening in the tilt bar.

13. The connector system for connecting the tilt bar to the seat frame of claim 12, wherein the tilt bar is rotatably connected to the nut.

14. The connector system for connecting the tilt bar to the seat frame of claim 12, further comprising a washer positioned between the frame connector and the bolt.

15. The connector system for connecting the tilt bar to the seat frame of claim 12, wherein the frame member is a tilt bar.

16. A method of assembling an article of furniture having a seat frame situated between a pair of frame members, the method of assembly comprising the steps of:
attaching a stud to a frame member, the stud having a threaded opening;
positioning a frame connector, having a through opening with a first end and an opposite second end, over the stud, such that the threaded stud is inserted into the first end of the through opening; and
positioning a bolt through the opposite second end of the through opening and engaging the bolt with the threaded opening of the stud.

17. The method of assembling a chair of claim 16, further comprising the steps of:
attaching a second stud to the frame member, the second stud having a ribbed body;
fixing a lateral rod to the second stud, wherein the ribbed body forms a compression fit with the lateral rod.

18. The method of assembling a chair of claim 16, wherein the second stud further includes a screw driver interface.

19. The method of assembling a chair of claim 16, further comprising the step of attaching the frame connector to the seat frame.

20. The article of furniture of claim 2, further comprising one additional first connector assembly and five additional second connector assemblies.
